(19) United States
(12) Patent Application Publication
(10) Pub. No.: US 2010/0086386 A1
(43) Pub. Date: Apr. 8, 2010

(54) CAR SLIDER ASSEMBLY

(76) Inventor: Brint D. Freeman, St. Anthony, ID (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/575,890

(22) Filed: Oct. 8, 2009

Related U.S. Application Data
(60) Provisional application No. 61/103,771, filed on Oct. 8, 2008.

(51) Int. Cl. B60P 3/07; B60P 1/32; B60P 1/16; B60P 1/43; B62D 63/08

(52) U.S. Cl. 414/477

(57) ABSTRACT

A slider assembly for loading and unloading a vehicle from a trailer includes a frame assembly movable between retracted and extended positions, a drive system including a drive motor and a linkage assembly operably coupling the drive motor with the frame assembly, wherein the drive system moves the frame assembly between the retracted and the extended positions thereof, and a wheel assembly movable between an extending position, wherein the wheel assembly extends away from the frame assembly and supports the frame above a ground surface and an angular ramp extending rearwardly of the trailer, and a retracted position, wherein the wheel assembly is retracted to a position proximate the frame assembly, and wherein the wheel assembly supports the frame assembly at a substantially constant height above a ground surface as the frame assembly is moved between the retracted and extended positions, and a controller adapted to control the drive system and move the frame assembly between the retracted and extended positions thereof, and to control the wheel assembly between the retracted and extended positions.

### CROSS REFERENCE TO RELATED APPLICATION

This application claims the benefit of U.S. Provisional Application No. 61/103,771, filed Oct. 8, 2008, entitled CAR SLIDER ASSEMBLY, which is hereby incorporated herein by reference in its entirety.

### BACKGROUND OF THE INVENTION

The present invention relates to a trailer for transporting an automobile thereon, and in particular to a trailer and slider assembly for loading and unloading vehicles from a vehicle transport trailer.

### SUMMARY OF THE INVENTION

One aspect of the present invention is to provide a trailer assembly for transporting an automobile comprising a trailer, a ramp, and a slider assembly. The trailer comprises a housing including a plurality of sidewalls and a top wall that cooperate to form an interior compartment adapted to house an automobile therein, and at least a pair of wheels operably coupled to the housing for supporting the housing above a ground surface. The ramp extends rearward from the interior compartment and is adapted to contact a ground surface. The slider assembly comprises a frame assembly, a deck, a drive system and at least one wheel assembly. The deck system is supported above the frame assembly such that the deck is movable between a retracted position, wherein a majority of the deck and the frame assembly are located with the interior compartment of the housing, and an extended position, wherein a majority of the deck and the frame assembly are located outside of the interior compartment of the housing. The drive system includes a drive motor and a linkage assembly operably coupling the drive motor and the frame assembly to the deck, wherein the drive system moves the frame assembly and the deck between the retracted and extended positions. The at least one wheel assembly is movable between an extended position, wherein the wheel assembly extends away from the frame assembly, and a retracted position, wherein the wheel assembly is retracted to a position proximate the frame assembly. The at least one wheel assembly is adapted to support the frame assembly above the ground surface and the ramp as the frame assembly is moved between a retracted and extended positions thereof, and to support the deck in a substantially horizontal position while the frame assembly is moved between the retracted and extended positions thereof. The controller is adapted to control the drive system and move the frame assembly between the retracted and extended positions thereon, and to control the at least one wheel assembly between the retracted and extended positions thereof.

Another aspect of the present invention is to provide a slider assembly for loading and unloading a vehicle from a trailer, comprising a frame assembly, a drive system, at least one wheel assembly, and a controller. The frame assembly is movable between a retracted position, wherein a majority of the frame assembly is adapted to be positioned above a frame of a trailer, and an extended position, wherein a majority of the frame assembly is adapted to be located rearward of a trailer. The drive system includes a drive motor and a linkage assembly operably coupling the drive motor with the frame assembly, wherein the drive system moves the frame assembly between the retraced and extended positions thereof. The at least one wheel assembly is movable between an extended position, wherein the wheel assembly extends away from the frame assembly, and a retracted position, wherein the wheel assembly is retracted to a position proximate the frame assembly. The at least one wheel assembly is adapted to support the frame assembly above a ramp of a trailer and a ground surface as the frame assembly is moved between a retracted and an extended positions thereof, and to support the frame assembly at a substantially constant height above a ground surface as a supported frame assembly is moved between the refracted and the extended positions. The controller is adapted to control the drive system and move the frame assembly between the retracted and extended positions thereof, and to control the at least one wheel assembly between the retracted and extended positions thereof.

The principal objects of the present invention are to provide a system for loading and unloading of a vehicle into and from a transport trailer, wherein the loading and unloading process is more easily accomplished, thereby reducing the time associated with heretofore known loading and unloading processes, while simultaneously reducing the chances of damaging the transported vehicle during the loading and unloading processes. The present inventive slider assembly may be retrofitted into existing trailers and/or new production trailers without significantly modifying the trailer design, and can be operated by even unskilled personnel once installed. Moreover, the slider assembly provides a ready-made platform for displaying the transported automobile at car shows and the like, increases the safety of towing the trailer to and from display events, is capable of a long operating life, and is particularly well adapted for the proposed use.

These and other advantages of the invention will be further understood and appreciated by those skilled in the art by reference to the following written specifications, claims and appended drawings.

### BRIEF DESCRIPTION OF THE DRAWINGS

FIG. 1 is a perspective view of a trailer assembly including a slider assembly in a retracted position, and embodying the present invention;

FIG. 2 is a side view of the trailer assembly with the slider assembly in a retracted position and a ramp in an extended position;

FIG. 3A is a side view of a trailer assembly with the slider assembly shown in a partially extended position and supported above the ramp by a wheel assembly;

FIG. 3B is a side view of a trailer assembly with the slider assembly shown in a partially extended position and supported above a ground surface by the wheel assembly;

FIG. 3C is a perspective view of a trailer assembly with the slider assembly shown in a fully extended and fully raised position;

FIG. 3D is a side view of the slider assembly, wherein the wheel assemblies are shown in a partially retracted position, and the slider assembly is shown in the fully lowered position;

FIG. 3E is a side view of the slider assembly, wherein the wheel assemblies are shown in a fully retracted position;

FIG. 4 is a top plan view of the slider assembly;

FIG. 5 is a side view of the slider assembly;

FIG. 6 is a perspective view of a lower portion of a roller assembly of the slider assembly;

FIG. 7 is a partial cross-sectional end view of the roller assembly;

FIG. 8 is a perspective view of an upper portion of the roller assembly;

FIG. 9 is a perspective view of a drive system including a controller, an electric motor and a hydraulic pump;

FIG. 10 is a side view of the drive system;

FIG. 11 is a bottom perspective view of the wheel assemblies; and

FIG. 12 is a side view of a retention system for securing a vehicle to the slider assembly.

### DETAILED DESCRIPTION OF THE PREFERRED EMBODIMENTS

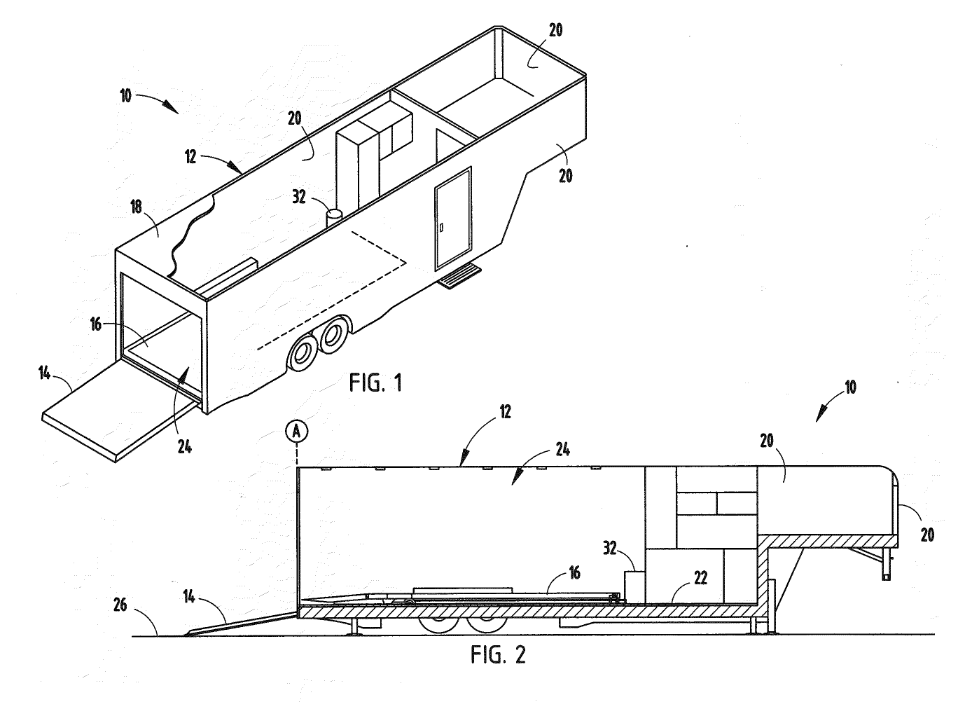

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 10 (FIGS. 1 and 2) generally designates a trailer assembly that includes a trailer 12, a ramp 14, and a slider assembly 16 embodying the present invention. In the illustrated example, the trailer 12 comprises a top wall 18, a plurality of sidewalls 20 and a bottom wall 22 that cooperate to form an interior compartment 24. The ramp 14 extends rearwardly from the interior compartment 24 of the trailer 12 and angles downward to abut a ground surface 26. The ramp 14 is movable between a retracted position, wherein the ramp is received into the interior compartment 24 of the trailer 12 and is positioned below the slider assembly 16 (as illustrated in FIG. 1), and an extended position, wherein the ramp 14 extends rearwardly from the trailer 12 and abuts the ground 26 (as illustrated in FIG. 2).

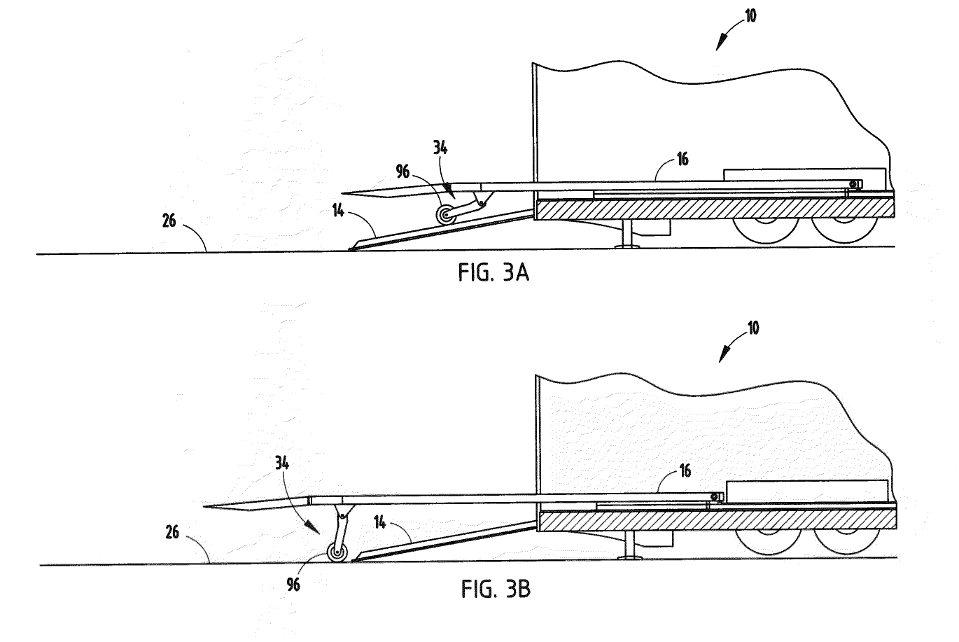

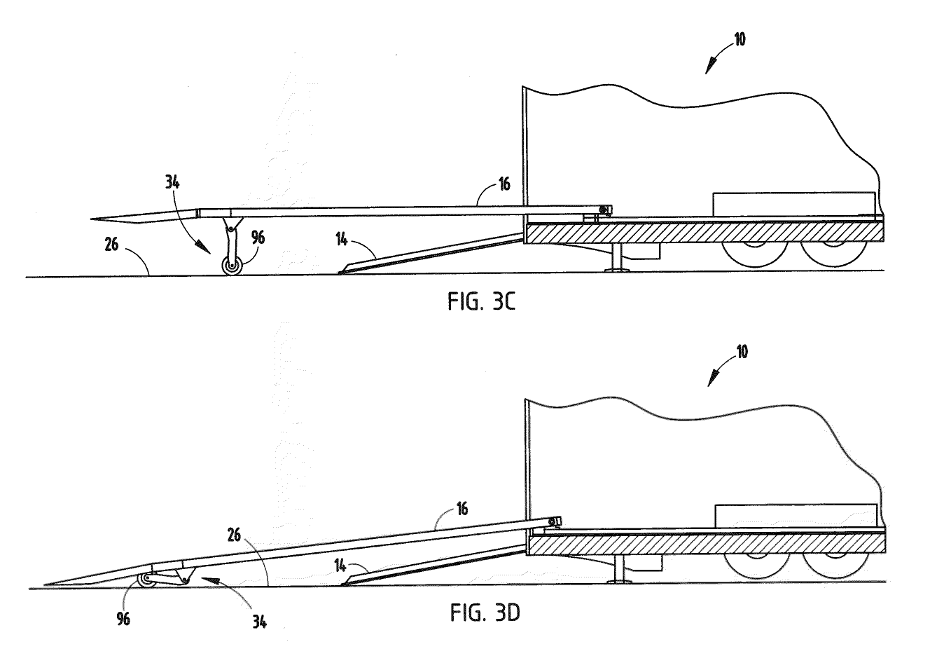

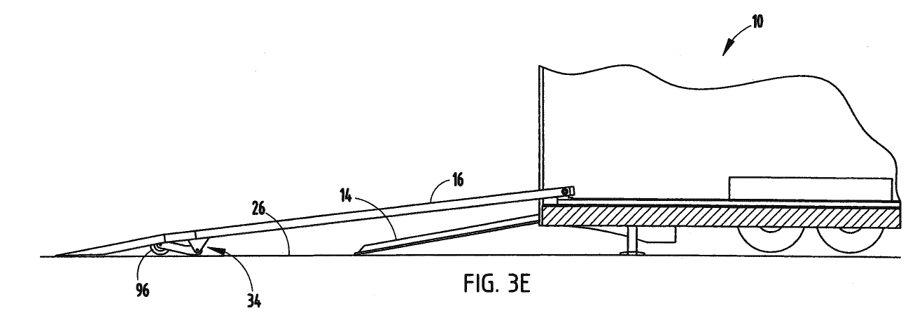

FIGS. 3A-3D illustrate the slider assembly 16 being moved from a fully retracted position A (FIG. 3A), wherein the slider assembly 16 is located within the interior compartment 24 of the trailer 12, and an extended position B (FIG. 1D), wherein the slider assembly 16 extends rearwardly from the interior compartment 24 of the trailer 12. While FIGS. 3A-3D best illustrate the unloading of a vehicle from within the interior compartment 24 of the trailer 12 by use of the slider assembly 16, the reverse process is completed to load the vehicle into the trailer 12.

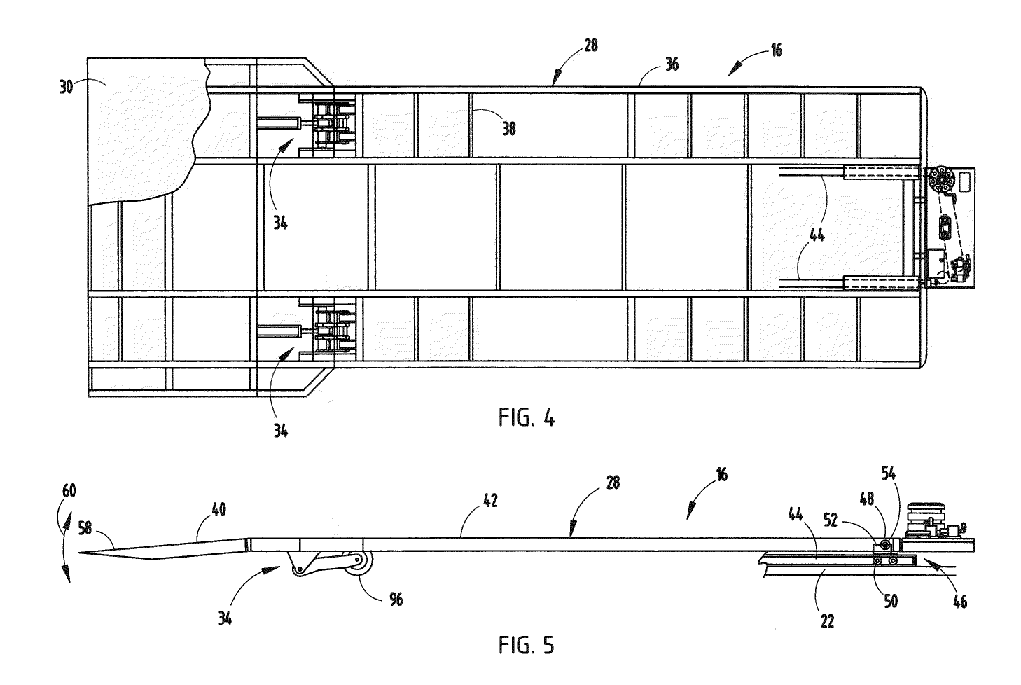

The slider assembly 16 (FIG. 4) includes a frame assembly 28, a deck 30, a drive system 32 adapted to move the frame assembly between the retracted position A and the extended position B, and a pair of wheel assemblies 34 supporting the frame assembly 28 above the ground surface 26.

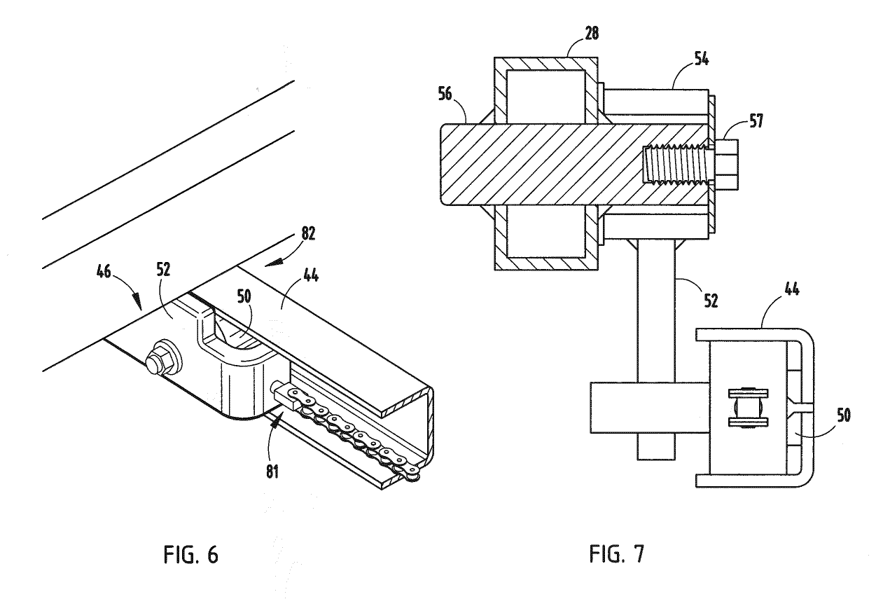

The frame assembly 28 (FIGS. 4 and 5) includes a plurality of longitudinal frame members 36 and lateral frame members 38 that cooperate to form a surface upon which the deck 30 is supported. An aft portion 40 of the frame assembly 28 angles gradually downward from a main body portion 42 thereof, thereby facilitating loading and unloading of the vehicle to be transported. Alternatively, the aft portion 40 may be hingedly connected to the frame assembly 28, thereby allowing the relative angle between the aft portion 40 and the frame 28 to be adjusted as the frame assembly 28 is raised or lowered with respect to the ground 26. The frame assembly 28 is rollably from the trailer 12 by a pair of outwardly-facing C-channels 44 that extend longitudinally along and are secured to the bottom wall 22 of the trailer 12. A roller assembly 46 rollably secures a fore end 48 of the frame assembly 28 to the channels 44. Each roller assembly 46 (FIGS. 6-8) includes a pair of guide bearings 50 that guide along and within the respective C-shaped channels 44 as the frame assembly 28 is moved between the retracted and extended positions thereof. A support plate 52 extends upwardly from the guide bearings 50 and supports a bushing 54 that is pivotally coupled with a pivot pin 56 via a washer and bolt assembly 57, the pivot pin 56 being fixedly secured to a mounting member (not shown) that is removably secured to the frame assembly 28 via hardware, such as a plurality of mounting bolts, thereby allowing the associated assembly to be easily removed. In operation, The roller assembly 46 allows an aft end 58 of the frame assembly 42 to pivot in an upward and downward arcuate direction, as indicated and represented by directional arrows 60, while the frame assembly 28 is moved between the retracted and extended positions by a pair of drive chains 62, as described below. Although in the present example the alignment of the frame assembly 28 with respect to the trailer 12 is controlled via a computerized controller as described below, alternatively an alignment adjustment assembly 100 includes a tensioning plate 102 linearly adjustable with respect to the bushing 54 via an adjustment bolt 104 and held in tension therewith by a coil spring 106. In operation, the assembly 100 actively prevents the guide bearing 50 from binding within the associated channels 44 as the frame assembly 28 is moved between the retracted and extended positions.

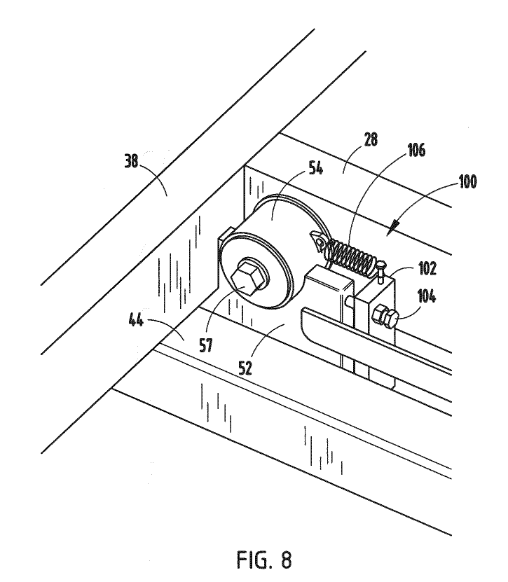

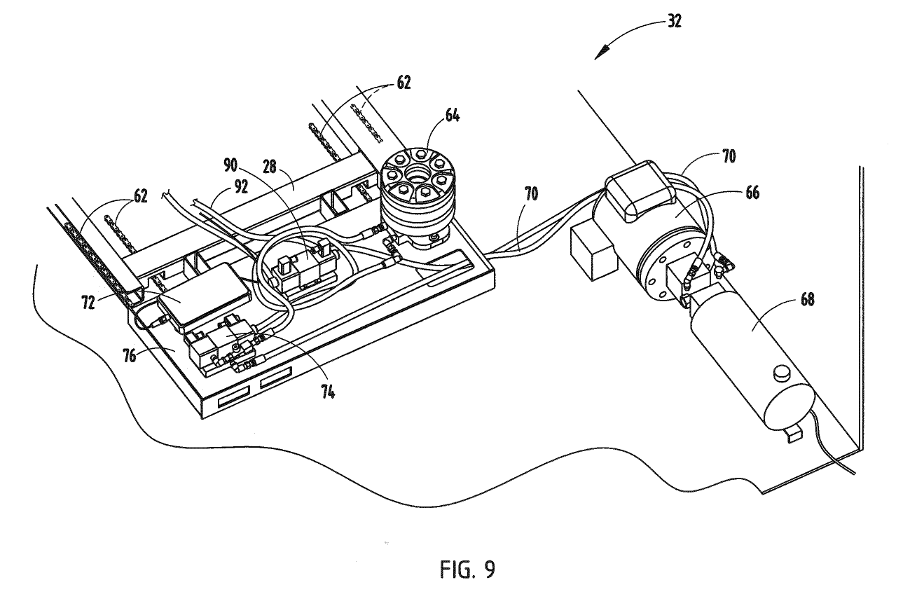

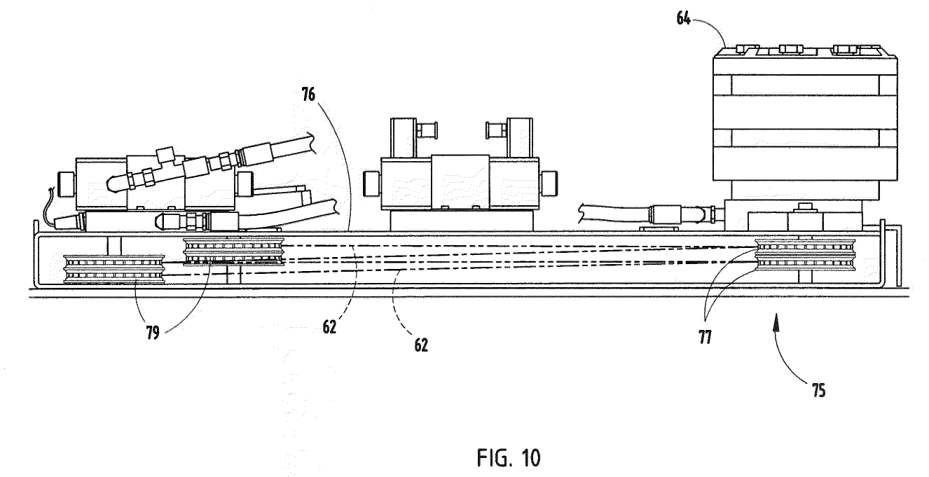

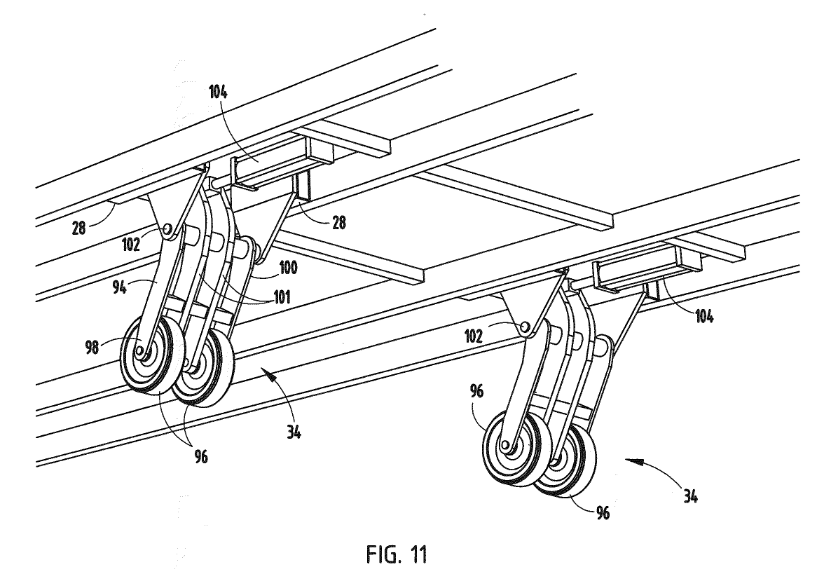

The drive system 32 (FIG. 9) includes a hydraulic drive motor 64 powered by an electrical motor 66 and a hydraulic pump 66 coupled to the hydraulic motor 64 via a plurality of hydraulic lines 70. The electric motor 66 receives electrical power from a gas powered generator, an external AC power source, and/or an external DC power source, such as that supplied from the vehicle used to tow the trailer assembly 10. The hydraulic pump 68 is controlled via a controller 72 which controls hydraulic valves 74. The drive motor 64 (FIG. 10) is coupled to a pair of drive chains 62 via a sprocket linkage 75 situated below a mounting platform 76 that supports the drive motor 64, the controller 72 and the hydraulic valves 74 thereon. The motion of the drive chains 62 are synchronized with one another via a linkage assembly mechanically coupling drive sprockets 77 that are in direct contact with the respective drive chains 62. The drive chains 62 each form a closed loop with respective pairings of a drive sprocket 79 at one end and an idler roller 79 at an opposite end. It is noted that the idler rollers 79 may be either directly coupled to the respective channels 44, or connected via a chain tensioning device (not shown). As best illustrated in FIG. 8, each chain 62 is connected to the support plate 52 at points 81, 82 thereby forming the closed loop.

The controller 72 further controls a second set of hydraulic valves 90, that are in turn operably coupled to the respective wheel assemblies 34 via hydraulic lines 92. Each wheel assembly 34 (FIG. 11) includes a swing arm 94, a pair of wheels 96 that are operably coupled to a distal end 98 of the swing arm 94, and a proximate end 100 pivotally coupled to the frame assembly 28 via a pivot pin 102. While the pair of wheels 96 are shown in a side-by-side arrangement, it is not that the wheels may also be oriented in a tandem arrangement with respect to one another. Each wheel assembly 34 further includes a hydraulic cylinder 104 pivotally coupled to an actuator arm 101 extending inward of the proximate end 100. As best illustrated in FIGS. 3A-3D, the controller 72 operates the position of the wheel assemblies 34 with respect to the frame assembly 28 so as to maintain the frame assembly 28 and deck 30 in a substantially horizontal orientation with respect to the ground surface 26 and the frame assembly 28 and deck 30 at a relatively constant height above the ground surface 26 as the frame assembly 28 and deck 30 are moved between the retracted position A and the extended position B.

In operation, the wheel assemblies 34 are in a retracted position relative to the frame assembly 28 when the frame assembly 28 and deck 30 are in the retracted position A. As the frame assembly 28 is moved from the retracted position A towards the extended position B, the wheel assemblies 34 (FIG. 3A) support the frame assembly 28 from the ramp 14. The wheel assemblies 34 continue to be extended away from the frame assembly 28 as the frame assembly 28 is withdrawn from the interior compartment 24 until the wheels 96 of the wheel assemblies 34 contact the ground surface 26 (FIG. 2B). An altitude or angle relationship or level sensing device (not shown), such as a parallel bar and control switches, a laser device, a rotary position sensor, mercury leveling switches, magnetic proximity sensors, and the like, is utilized to monitor the orientation of the frame assembly along the length thereof thereby maintaining a proper relationship between the components of the slider assembly 16 and the trailer 12 to prevent binding and damage, as well as to maintain the proper horizontal orientation and elevational height of the frame assembly 28 and the deck 30. It is noted that the sensor may also be employed to maintain the frame assembly 28 in a horizontal orientation should the wheels 96 encounter debris while being moved between the retracted and extended positions. The wheel assemblies 34 continue to support the frame assembly 28 above the ground surface 26 until the frame assembly and deck 30 are moved to the fully extended position (FIG. 3C). The wheel assemblies 34 are then moved into an unloading position, wherein the wheel assemblies 34 are refracted proximate the frame assembly 28 (FIG. 3D), such that the aft end 58 of the frame assembly 28 contacts the ground surface 26. Each wheel assembly 34 can further be moved into a storage position, as best illustrated in FIG. 3E, wherein the wheels 96 are retracted from contact with the ground surface 26, thereby ensuring that the frame assembly 28, the deck 30 (and the supported vehicle) are solely supported by the frame assembly 28. It is noted that the wheel assemblies 34 can also remain in the fully extended position (FIG. 3C) to provide a “vehicle show” position, thereby allowing easy viewing of all aspects of the supported vehicle, including an underside thereof. The increased elevation of the frame assembly 28 as provided by the wheel assemblies 34 being in the fully extended position, elevates the transported vehicle, thereby allowing easier inspection thereof, including the underside of the vehicle.

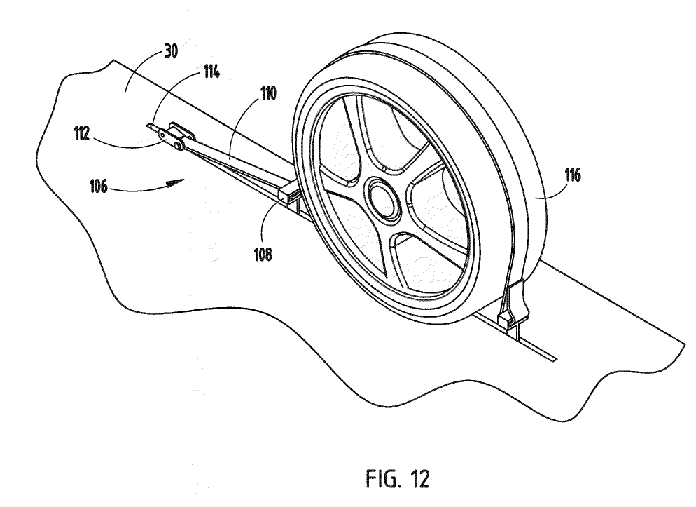

The transported vehicle is held in position on the deck 30 (FIG. 12) by a retention system 106 comprising retention brackets 108, a nylon strap 110 and a ratcheting device 112. Specifically, each of the retention brackets 108 extends through a slot located within the deck 30 and is coupled to a member of the frame assembly 28. The strap 110 extends through the brackets 108 and is received by the ratcheting device 112 that is utilized to tightly secure a tire 116 of the vehicle to be transported between the strap 110 and the deck 30. It is noted that the strap 110 abuts only the tire 116 of the transported vehicle, thereby eliminating any interaction between metal components of the transported vehicle and the slider assembly 16. Further, this retention system 106 allows free action of the suspension system of the transported vehicle, thereby increasing control of the towing vehicle.

The present inventive system for loading and unloading of a vehicle into and from a transport trailer allows for a more easily accomplished loading/unloading process thereby reducing the time associated with heretofore known loading and unloading processes, while simultaneously reducing the chances of damaging the transported vehicle during the loading and unloading processes. The present inventive slider assembly may be retrofitted into existing trailers and/or new production trailers without significantly modifying the trailer design, can be pre-assembled prior to such retrofitting and can be operated by even unskilled personnel once installed. Moreover, the slider assembly provides a ready-made platform for displaying the transported automobile at car shows and the like, increases the safety of towing the trailer to and from display events, is capable of a long operating life, and is particularly well adapted for the proposed use.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A trailer assembly for transporting an automobile, comprising:
a trailer, comprising:
a housing including a plurality of side walls and a top wall that cooperate to form an interior compartment adapted to house an automobile therein; and
at least a pair of wheels operably coupled to the housing for supporting the housing above a ground surface; and
a ramp extending rearward from the interior compartment and adapted to contact
a ground surface; and
a slider assembly, comprising:
a frame assembly;
a deck supported above the frame assembly such that the deck is movable between a retracted position, wherein a majority of the deck and the frame assembly are located within the interior compartment of the housing, and an extended position, wherein a majority of the deck and the frame assembly are located outside of the interior compartment of the housing;
a drive system including a drive motor and a linkage assembly operably coupling the drive motor with the frame assembly and the deck, wherein the drive system moves the frame assembly and the deck between the retracted and extended positions;
at least one wheel assembly movable between an extending position, wherein the wheel assembly extends away from the frame assembly, and a retracted position, wherein the wheel assembly is retracted to a position proximate the frame assembly, the at least one wheel assembly adapted to support the frame assembly above the ramp and a ground surface as the frame assembly is moved between the retracted and extended positions thereof, and wherein the deck remains in a substantially horizontal position while being moved between the retracted and extended positions; and
a controller adapted to control the drive system and move the frame assembly between the retracted and extended positions thereof, and to control the at least one wheel assembly between the retracted and the extended positions thereof.

2. The trailer assembly of claim 1, wherein the linkage assembly includes at least one drive chain.

3. The trailer assembly of claim 2, wherein the at least one drive chain includes a pair of drive chains, and wherein the drive system further includes a sprocket assembly that synchronizes the pair of drive chains as the frame assembly is moved between the retracted and the extended positions thereof.

4. The trailer assembly of claim 1, wherein the drive motor comprises a hydraulic motor, and wherein the drive system includes an electric motor and a hydraulic pump operably coupled to the hydraulic motor.

5. The trailer assembly of claim 1, wherein the controller is operable via a remote control.

6. The trailer assembly of claim 5, wherein the remote control is a wireless remote control.

7. The trailer assembly of claim 5, wherein the controller prevents adjustment of the at least one wheel assembly between the retracted and the extended positions thereof via the remote control unless the frame assembly is in a fully extended position.

8. The trailer assembly of claim 1, wherein the at least one arm assembly includes a pair of arm assemblies spaced across a width of the frame assembly.

9. The trailer assembly of claim 8, further including:
a level sensing device that senses the orientation of the frame assembly along a length of the frame assembly relative to horizontal, and is operably coupled to the controller, such that the controller can maintain the frame assembly in the substantially horizontal position by adjusting the position of the pair of wheel assemblies between the retracted and extended position thereof as the frame assembly is moved between the retracted and extended positions thereof.

10. The trailer assembly of claim 8, wherein the movement of the pair of wheel assemblies between the extended and retracted positions thereof are at least partially synchronized with respect to one another via a hydraulic splitter.

11. The trailer assembly of claim 1, further including:
a retention system adapted to operably secure a vehicle supported above the deck to the frame assembly.

12. The trailer assembly of claim 11, wherein the retention system is adapted to contract only a tire of a vehicle supported above the deck.

13. The trailer assembly of claim 11, wherein the retention system is located substantially proximate a location of the at least one wheel assembly along a length of the frame assembly.

14. The trailer assembly of claim 1, further including:
a least a select one of a gas powered generator, a 240 volt AC external power supply, and a DC external power supply from a towing vehicle, operably coupled to the drive motor.

15. The trailer assembly of claim 1, wherein the slider assembly is a modular system that is preassembled before assembly with the trailer.

16. A slider assembly for loading and unloading a vehicle from a trailer, comprising:
a frame assembly movable between a retracted position, wherein a majority of the frame assembly is adapted to be positioned above a frame of a trailer, and an extended position, wherein a majority the frame assembly is adapted to be located rearward of a frame of a trailer;
a drive system including a drive motor and a linkage assembly operably coupling the drive motor with the frame assembly, wherein the drive system moves the frame assembly between the retracted and extended positions thereof;
at least one wheel assembly movable between an extending position, wherein the wheel assembly extends away from the frame assembly, and a retracted position, wherein the wheel assembly is retracted to a position proximate the frame assembly, the at least one wheel assembly adapted to support the frame assembly above a downwardly-angled ramp of a trailer and a ground surface as the frame assembly is moved between the retracted and extended positions thereof, and wherein the at least one wheel assembly is adapted to contact a ramp and a ground surface and support the frame assembly in a substantially horizontal position as the frame assembly is moved between the retracted position and the extended position; and
a controller adapted to control the drive system and move the frame assembly between the refracted and extended positions thereof, and to control the at least one wheel assembly between the retracted and the extended positions thereof.

17. The slider assembly of claim 16, further including:
a deck supported above the frame assembly and adapted to directly support a vehicle thereon.

18. The slider assembly of claim 16, wherein the linkage assembly includes at least one drive chain.

19. The slider assembly of claim 18, wherein the at least one drive chain includes a pair of drive chains, and wherein the drive system further includes a sprocket assembly that synchronizes the pair of drive chains as the frame assembly is moved between the retracted and the extended positions thereof.

20. The slider assembly of claim 16, wherein the drive motor comprises a hydraulic motor, and wherein the drive system includes an electric motor and a hydraulic pump operably coupled to the hydraulic motor.

21. The slider assembly of claim 16, wherein the controller is operable via a remote control.

22. The slider assembly of claim 21, wherein the remote control is a wireless remote control.

23. The slider assembly of claim 21, wherein the controller prevents adjustment of the at least one wheel assembly between the retracted and the extended positions via the remote control unless the frame assembly is in a fully extended position.

24. The slider assembly of claim 16, wherein the at least one arm assembly includes a pair of arm assemblies spaced across a width of the frame assembly.

25. The slider assembly of claim 24, further including:
a level sensing device that senses the orientation of the frame assembly along a length of the frame assembly relative to a horizontal orientation, and is operably coupled to the controller, such that the controller can maintain the frame assembly in a substantially horizontal orientation by adjusting the position pair of wheel assemblies between the retracted and extended positions thereof as the frame assembly is moved between the retracted and extended positions thereof.

26. The slider assembly of claim 25, wherein the movement of the pair of wheel assemblies between the extended and retracted positions thereof are at least partially synchronized with respect to one another via a hydraulic splitter.

27. The slider assembly of claim 16, further including:
a retention system adapted to operably secure a vehicle above the frame assembly.

28. The slider assembly of claim 27, wherein the retention system is adapted to contract only a tire of a vehicle supported above the frame assembly.

29. The slider assembly of claim 27, wherein the retention system is located substantially proximate a location of the at least one wheel assembly along a length of the frame assembly.

30. The slider assembly of claim 16, wherein the slider assembly is a modular assembly that may be preassembled before assembly with a trailer assembly.
